(19) United States
(12) Patent Application Publication
(10) Pub. No.: US 2014/0205012 A1
(43) Pub. Date: Jul. 24, 2014

(54) METHOD AND APPARATUS USING SOFTWARE ENGINE AND HARDWARE ENGINE COLLABORATED WITH EACH OTHER TO ACHIEVE HYBRID VIDEO ENCODING

(71) Applicant: MEDIATEK INC., Hsin-Chu (TW)

(72) Inventors: Kun-Bin Lee, Taipei City (TW); Cheng-Hung Liu, Hsinchu City (TW); Han-Liang Chou, Hsinchu County (TW); Chi-Cheng Ju, Hsinchu City (TW)

(73) Assignee: MEDIATEK INC., Hsin-Chu (TW)

(21) Appl. No.: 14/154,132

(22) Filed: Jan. 13, 2014

Related U.S. Application Data
(60) Provisional application No. 61/754,938, filed on Jan. 21, 2013.

(51) Int. Cl. H04N 19/433

(52) U.S. Cl. CPC H04N 19/00515
USPC 375/240.16

(57) ABSTRACT

One video encoding method includes: performing a first part of a video encoding operation by a software engine with instructions, wherein the first part of the video encoding operation comprises at least a motion estimation function; delivering a motion estimation result generated by the motion estimation function to a hardware engine; and performing a second part of the video encoding operation by the hardware engine. Another video encoding method includes: performing a first part of a video encoding operation by a software engine with instructions and a cache buffer; performing a second part of the video encoding operation by a hardware engine; performing data transfer between the software engine and the hardware engine through the cache buffer; and performing address synchronization to ensure that a same entry of the cache buffer is correctly addressed and accessed by both of the software engine and the hardware engine.

### CROSS REFERENCE TO RELATED APPLICATIONS

This application claims the benefit of U.S. provisional application No. 61/754,938, filed on Jan. 21, 2013 and incorporated herein by reference.

### BACKGROUND

The disclosed embodiments of the present invention relate to video encoding, and more particularly, to a method and apparatus using a software engine and a hardware engine collaborated with each other to achieve hybrid video encoding.

Although a full hardware video encoder or video codec meets the performance requirement, the cost of such a full hardware solution is still high. Computation capability of a programmable engine (i.e., a software engine which performs functions by instruction execution) becomes better and better, but still can't meet the high-end specification of video encoding, such as 720 p@30 fps or 1080 p@30 fps encoding. In addition, power consumption of the programmable engine is higher than that of the full hardware solution. Furthermore, the memory bandwidth could be another issue when a programmable engine is used. Besides, resource of the programmable engine could be time-variant during video encoding when different applications, including an operation system (OS), are also running on the same programmable engine.

Thus, there is a need for an innovative video encoding design which can take advantage/benefit possessed by hardware-based implementation and software-based implementation to accomplish the video encoding operation.

### SUMMARY

In accordance with exemplary embodiments of the present invention, a method and apparatus using a software engine and a hardware engine collaborated with each other to achieve hybrid video encoding are proposed.

According to a first aspect of the present invention, an exemplary video encoding method is disclosed. The exemplary video encoding method includes at least the following steps: performing a first part of a video encoding operation by a software engine with a plurality of instructions, wherein the first part of the video encoding operation comprises at least a motion estimation function; delivering a motion estimation result generated by the motion estimation function to a hardware engine; and performing a second part of the video encoding operation by the hardware engine.

According to a second aspect of the present invention, an exemplary video encoding method is disclosed. The exemplary video encoding method includes at least the following steps: performing a first part of a video encoding operation by a software engine with a plurality of instructions and a cache buffer; performing a second part of the video encoding operation by a hardware engine; performing data transfer between the software engine and the hardware engine through the cache buffer; and performing address synchronization to ensure that a same entry of the cache buffer is correctly addressed and accessed by both of the software engine and the hardware engine.

According to a third aspect of the present invention, an exemplary hybrid video encoder is disclosed. The exemplary hybrid video encoder includes a software engine and a hardware engine. The software engine is arranged for performing a first part of a video encoding operation by executing a plurality of instructions, wherein the first part of the video encoding operation comprises at least a motion estimation function. The hardware engine is coupled to the software engine, and arranged for receiving a motion estimation result generated by the motion estimation function, and performing a second part of the video encoding operation.

According to a fourth aspect of the present invention, an exemplary hybrid video encoder is disclosed. The exemplary hybrid video encoder includes a software engine and a hardware engine. The software engine is arranged for performing a first part of a video encoding operation by executing a plurality of instructions, wherein the software engine comprises a cache buffer. The hardware engine is arranged for performing a second part of the video encoding operation, wherein data transfer is performed between the software engine and the hardware engine through the cache buffer, and the hardware engine further performs address synchronization to ensure a same entry of the cache buffer is correctly addressed and accessed by the software engine and the hardware engine.

In accordance with the present invention, a hybrid video encoder or codec design between a full hardware solution and a full software solution is proposed for good tradeoff of cost and other factors (e.g., power consumption, memory bandwidth, etc.). In one exemplary design, at least motion estimation is implemented in a software side, and other encoding steps other than that done by the software side are implemented by hardware to complete the video encoding. The proposed solution is therefore named hybrid solution/hybrid video encoder herein.

In this invention, several methods are disclosed. They all have the same characteristics that at least motion estimation is implemented by software instructions running on programmable engine(s), such as a central processing unit (CPU) like an ARM-based processor, a digital signal processor (DSP), a graphics processing unit (GPU), etc.

The proposed approach adopts the hybrid solution with at least motion estimation implemented by software to take advantage of new instructions available in a programmable processor (i.e., a software engine) and a large cache buffer of the programmable processor. Furthermore, at least one of other parts of the video encoding operation, such as motion compensation, intra prediction, transformation/quantization, inverse transformation, quantization, post processing (e.g., deblocking filter, sample adaptive offset filter, adaptive loop filter, etc), entropy encoding, is implemented by a hardware engine (i.e., pure hardware). In the proposed hybrid solution, at least part of data stored in the cache buffer of the programmable processor is accessed by both the hardware engine and the programmable processor. For example, as least part of a source frame is stored in the cache buffer, and is accessed by both the hardware engine and the programmable processor. For another example, as least part of a reference frame is stored in the cache buffer, and is accessed by both the hardware engine and the programmable processor. For another example, as least part of a current reconstructed frame is stored in the cache buffer, and is accessed by both the hardware engine and the programmable processor. For another example, as least part of an intermediate data generated either by a software function or by hardware is stored in the cache buffer, and is accessed by both the hardware engine and the programmable processor.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a hybrid video encoder according to a first embodiment of the present invention.

FIG. 2 is a diagram illustrating primary building blocks of a video encoding operation performed by the hybrid video encoder shown in FIG. 1.

FIG. 3 is a diagram illustrating an example of a software engine and a hardware engine doing tasks and exchange information with a time interval of a frame encoding time.

FIG. 4 is a diagram illustrating a hybrid video encoder according to a second embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is electrically connected to another device, that connection may be through a direct electrical connection, or through an indirect electrical connection via other devices and connections.

As the computation capability of a programmable engine is being continually improved, the modern CPU, DSP, or GPU usually has specific instructions (e.g., SIMD (single instruction multiple data) instruction sets) or acceleration units to improve the performance of regular computation. With some conventional fast motion estimation (ME) algorithms, software motion estimation is feasible on programmable engine(s). The proposed method takes advantage of new instructions available in a programmable processor. It also takes advantage of a large cache buffer of a programmable processor. At last, software motion estimation is feasible due to advanced motion estimation algorithm. The software performing ME function may run on a single programmable engine or multiple programmable engines (e.g., processor cores).

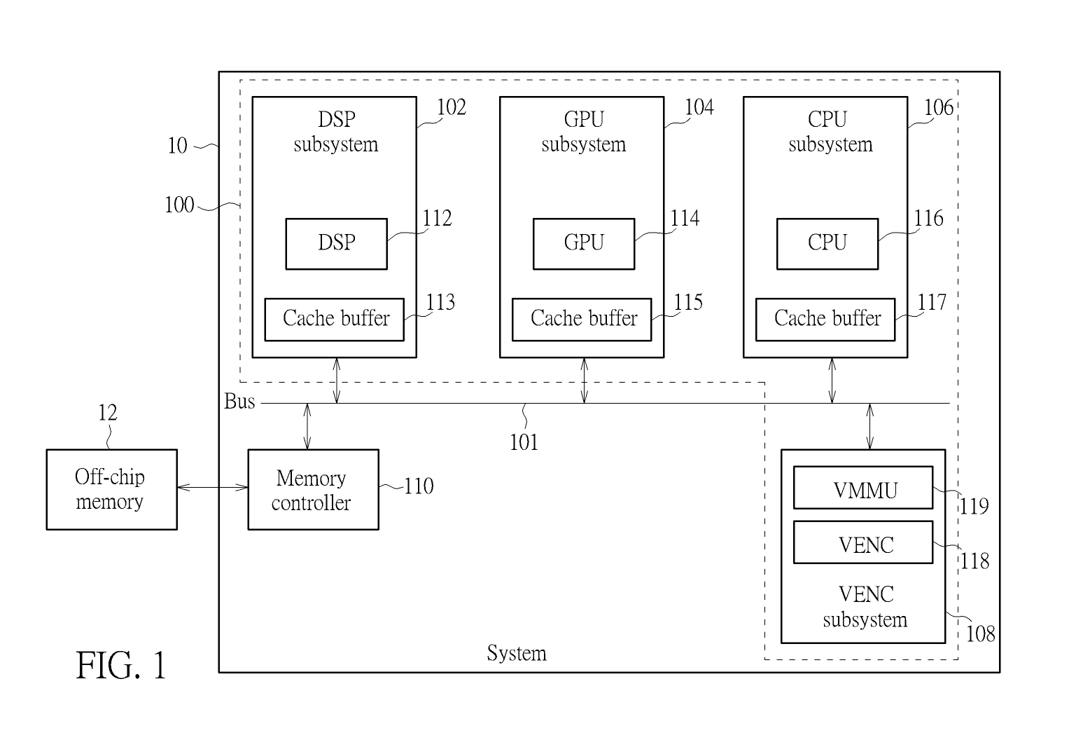

Please refer to FIG. 1, which is a block diagram illustrating a hybrid video encoder 100 according to a first embodiment of the present invention. FIG. 1 shows a simplified diagram of the video encoder 100 embedded in a system 10. That is, the hybrid video encoder 100 may be a portion of an electronic device, and more particularly, may be a portion of a main control circuit such as an integrated circuit (IC) within the electronic device. Examples of the electronic device may include, but not limited to, a mobile phone (e.g. a smartphone or a feature phone), a mobile computer (e.g. tablet computer), a personal digital assistant (PDA), and a personal computer such as a laptop computer or desktop computer. The hybrid video encoder 100 includes at least one software engine (i.e., software encoder part) which performs intended functionality by executing instructions (i.e., program codes), and further includes at least one hardware engine (i.e., hardware encoder part) which performs intended functionality by using pure hardware. In other words, the hybrid video encoder 100 is arranged to perform a video encoding operation through collaborated software and hardware.

In this embodiment, the system 10 may be a system on chip (SoC) having a plurality of programmable engines included therein, where one or more of the programmable engines may be used to serve as software engine(s) needed by the hybrid video encoder 10. By way of example, but not limitation, programmable engines may be a DSP subsystem 102, a GPU subsystem 104 and a CPU subsystem 106. It should be noted that the system 10 may further have other programmable hardware that can execute fed instructions or can be controlled by a sequencer. The DSP subsystem 102 includes a DSP (e.g. CEVA XC321 processor) 112 and a cache buffer 113. The GPU subsystem 104 includes a GPU (e.g. nVidia Tesla K20 processor) 114 and a cache buffer 115. The CPU subsystem 106 includes a CPU (e.g. Intel Xeon processor) 116 and a cache buffer 117. Each of the cache buffers 113, 115, 117 may be consisted of one or more caches. For example, the CPU 116 may have a level one (L1) cache and a level two (L2) cache. For another example, the CPU 116 may have multi-core architecture, and each core has its own level one (L1) cache while multiple cores share one level two (L2) cache. For another example, the CPU 116 may have multi-cluster architecture, and each cluster may have a single core or multiple cores. These clusters may further share a level three (L3) cache. Different types of programmable engines may further share a next level of cache hierarchical organization. For example, the CPU 116 and the GPU 114 may share one cache.

The software engine (i.e., one or more of DSP subsystem 102, GPU subsystem 104 and CPU subsystem 106) of the hybrid video encoder 100 is arranged to perform a first part of a video encoding operation by executing a plurality of instructions. For example, the first part of the video encoding operation may include at least a motion estimation (ME) function.

The video encoder (VENC) subsystem 108 in FIG. 1 is a hardware engine of the hybrid video encoder 100, and arranged to perform a second part of the video encoding operation by using pure hardware. The VENC subsystem 108 includes a video encoder (VENC) 118 and a memory management unit (VMMU) 119. Specifically, the VENC 118 performs other encoding steps other than that (e.g., motion estimation) done by the programmable engine(s). Hence, the second part of the video encoding operation may have at least one of a motion compensation function, an intra prediction function, a transform function (e.g., discrete cosine transform (DCT)), a quantization function, an inverse transform function (e.g., inverse DCT), an inverse quantization function, a post processing function (e.g. deblocking filter and sample adaptive offset filter), and an entropy encoding function. Besides, a main video buffer may be used to store source video frames, reconstructed frames, deblocked frames, or miscellaneous information used during video encoding. This main video buffer is usually allocated in an off-chip memory 12 such as a dynamic random access memory (DRAM), a static random access memory (SRAM), or a flash memory. However, this main video buffer may also be allocated in an on-chip memory (e.g., an embedded DRAM).

The programmable engines, including DSP subsystem 102, GPU subsystem 104 and CPU subsystem 106, the hardware engine (VENC subsystem 108), and a memory controller 110 are connected to a bus 101. Hence, each of the programmable engines and the hardware engine can access the off-chip memory 110 through the memory controller 110.

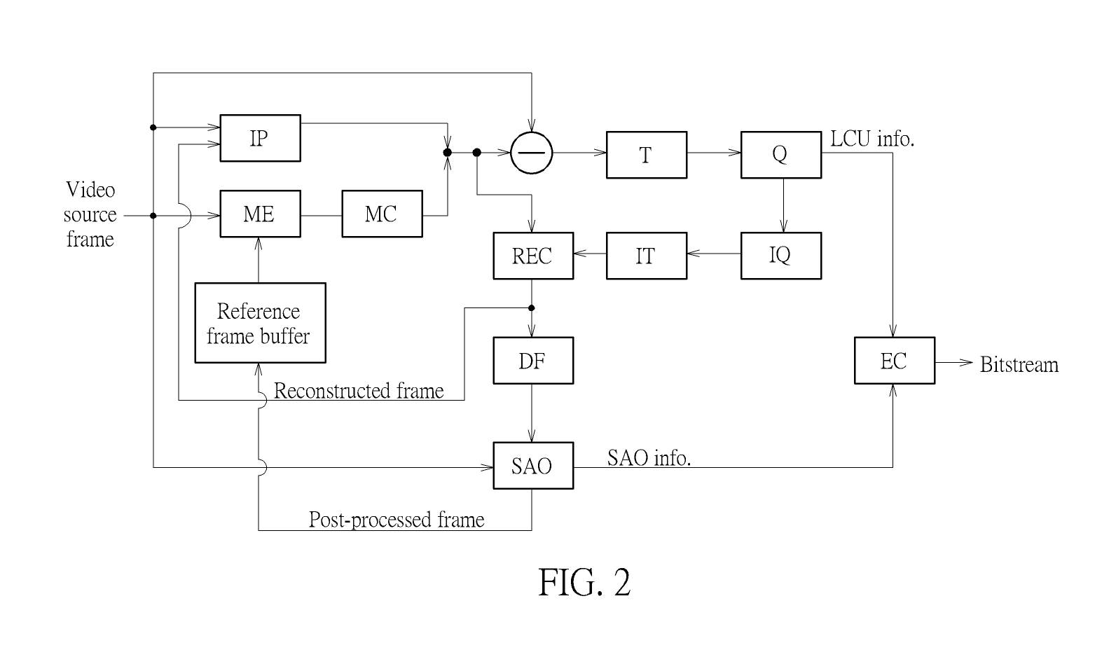

Please refer to FIG. 2, which is a diagram illustrating primary building blocks of a video encoding operation performed by the hybrid video encoder 100 shown in FIG. 1, where ME means motion estimation, MC means motion compensation, T means transformation, IT means inverse transformation, Q means quantization, IQ means inverse quantization, REC means reconstruction, IP means intra prediction, EC means entropy coding, DF means deblocking filter, and SAO means sample adaptive offset filter. Video encoding may be lossless or lossy, depending upon actual design consideration.

One or more building blocks are implemented by software (i.e., at least one of the programmable engines shown in FIG. 1), while others are implemented by hardware (i.e., the hardware engine shown in FIG. 1). It should be noted that software part at least implements the ME functionality. Some video standards may or may not have in-loop filter (s), such as DF or SAO. Video source frames carry raw data of original video frames, and the primary objective of the hybrid video encoder 100 is to compress the video source frame data in a lossless way or a lossy way. Reference frames are frames used to define future frames. In older video encoding standards, such as MPEG-2, only one reference frame (i.e., a previous frame) is used for P-frames. Two reference frames (i.e., one past frame and one future frame) are used for B-frames. In more advanced video standards, more reference frames can be used for encoding a frame. Reconstructed frames are pixel data generated by a video encoder/decoder through performing inverse encoding steps. A video decoder usually performs inverse encoding steps from compressed bitstream, while a video encoder usually performs inverse encoding steps after it acquires quantized coefficient data.

The reconstructed pixel data may become reference frames per definition of the used video standards (H.261, MPEG-2, H.264, etc.). In a first case where a video standard does not support in-loop filtering, DF and SAO shown in FIG. 2 are omitted. Hence, the reconstructed frame is stored into the reference frame buffer to serve as a reference frame. In a second case where a video standard only supports one in-loop filter (i.e., DF), SAO shown in FIG. 2 is omitted. Hence, the post-processed frame is the deblocked frame, and stored into the reference frame buffer to serve as a reference frame. In a third case where a video standard supports more than one in-loop filter (i.e., DF and SAO), the post-processed frame is the SAOed frame, and stored into the reference frame buffer to serve as a reference frame. To put it simply, the reference frame stored in the reference frame buffer may be a reconstructed frame or a post-processed frame, depending upon the video coding standard actually employed by the hybrid video encoder 100. In the following, a reconstructed frame may be used as an example of a reference frame for illustrative purposes. However, a skilled person should readily appreciate that a post-processed frame may take the place of the reconstructed frame to serve as a reference frame when the employed video coding standard supports in-loop filter(s). The in-loop filters shown in FIG. 2 are for illustrative purposes only. In an alternative design, a different in-loop filter, such as an adaptive loop filter (ALF), may also be used. Further, intermediate data are data generated during video encoding processing. Intermediate data, such as motion vector information, quantized transformed residues, decided encoding modes (inter/intra/direction and so on), etc., may or may not be encoded into the output bitstream.

Due to the hardware/software partition with at least one software-based encoding step (e.g., motion estimation) and other hardware-based encoding steps (e.g., motion compensation, reconstruction, etc.), it's possible that the reconstructed frame (or post-processed frame) could not be available for motion estimation. For example, normally ME needs a video source frame M and a reconstructed frame M−1 for motion vector search. However, under frame-based interaction, the hardware engine (VENC subsystem 108) of the hybrid video encoder 100 may still be processing frame M−1. In this case, original video frames (e.g., video source frame M−1) may be used as reference frames of motion estimation; that is, reconstructed frames (or post-processed frames) are not used as reference frames of motion estimation. It should be noted that the motion compensation would be performed upon reconstructed frame (or post-processed frame) M−1 according to the motion estimation result derived from video source frames M and M−1. To put it simply, the video encoding operation performed by the hybrid video encoder 100 includes a motion estimation function and a motion compensation; when the motion estimation function is performed, a video source frame is used as a reference frame needed by motion estimation; and when the following motion compensation function is performed, a reconstructed frame (or a post-processed frame) is used as a reference frame needed by motion compensation.

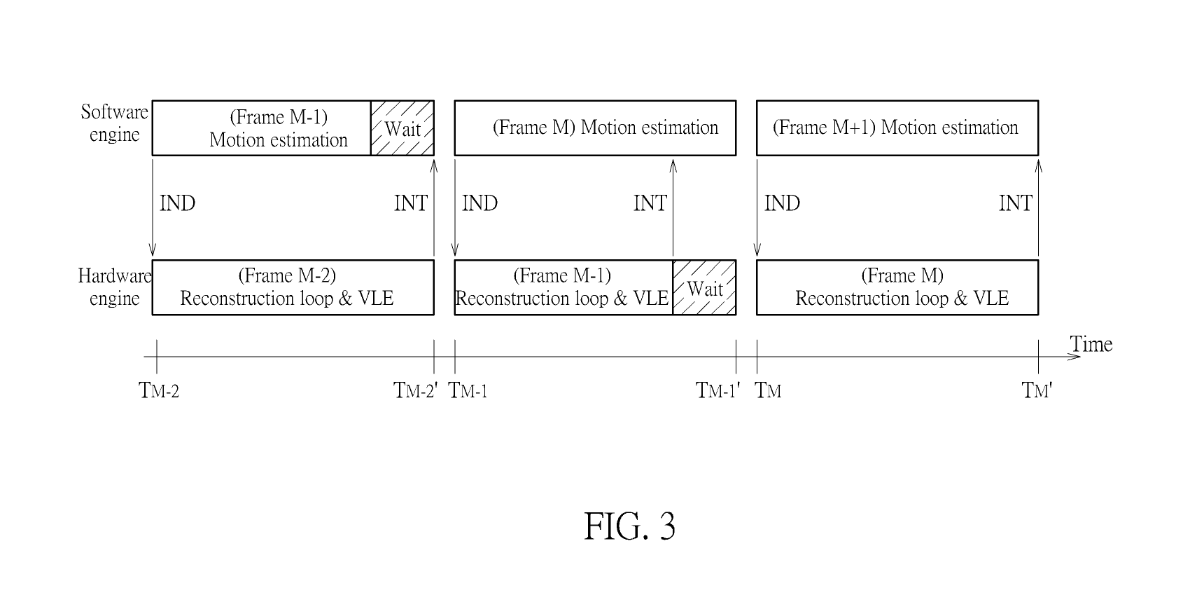

FIG. 3 is a diagram illustrating an example of a software engine and a hardware engine doing tasks and exchange information with a time interval of a frame encoding time. The software engine (e.g., CPU subsystem 106) performs motion estimation, and sends motion information (e.g., motion vectors) to the hardware engine (e.g., VENC subsystem 108). The hardware engine does tasks other than motion estimation of the video encoding processing, such as motion compensation, transform, quantization, invert transform, inverse quantization, entropy encoding, etc. In other words, there would be data transfer/transaction between the software engine and the hardware engine due to the fact that the complete video encoding operation is accomplished by co-working of the software engine and the hardware engine. Preferably, the data transfer/transaction is performed between the software engine and the hardware engine through a cache buffer. Further details of the cache mechanism will be described later. The interaction interval here means the time or space interval that software and hardware engines should communicate to each other. An example of the communication method is sending an interrupt signal INT from the hardware engine to the software engine. As shown in FIG. 3, the software engine generates an indicator IND at time T_{M-2} to notify the hardware engine, and transmits information associated with frame M−2 to the hardware part when finishing motion estimation of frame M−2 and starting motion estimation of the next frame M−1. When notified by the software engine, the hardware engine refers to the information given by the software engine to start the following encoding steps associated with the frame M−2 for obtaining a corresponding reconstructed frame M−2 and a bitstream of compressed frame M−2. The hardware engine notifies the software engine when finishing the following encoding steps associated with frame M−2 at time T_{M-2}′. As can be seen from FIG. 3, the processing speed of the software engine for frame M−1 is faster than that of the hardware engine for frame M−1. Hence, the software engine waits for finish of the following encoding steps associated with the frame M−2 that is performed by the hardware engine.

After being notified by the hardware engine, the software part transmits information associated with frame M−1 to the hardware engine and starts to perform motion estimation of the next frame M at time T_{M-1}. The software engine may also get information of compressed frame M−2 from the hardware engine. For example, the software engine may get the bitstream size, coding mode information, quality information, processing time information, and/or memory bandwidth information of compressed frame M−2 from the hardware engine. When notified by the software engine, the hardware engine refers to the information given by the software engine to start the following encoding steps associated with the frame M−1 for obtaining a corresponding reconstructed frame M−1. The hardware engine notifies the software engine when finishing the following encoding steps associated with frame M−1 at time T_{M-1}′. As can be seen from FIG. 3, the processing speed of the software part for frame M is slower than that of the hardware engine for frame M−1. Hence, the hardware engine waits for finish of the encoding step associated with the frame M that is performed by the software engine.

After finishing the motion estimation of frame M, the software engine transmits information associated with frame M to the hardware part and starts motion estimation of frame M+1 at time T_{M}. When notified by the software engine, the hardware engine refers to the information given by the software engine to start the following encoding steps associated with the frame M for obtaining a corresponding reconstructed frame M. The hardware engine notifies the software engine when finishing the following encoding steps associated with frame M at time T_{M}′. As can be seen from FIG. 3, the processing speed of the software engine for frame M+1 is equal to that of the hardware part for frame M. Hence, the hardware engine and the software engine are not required to wait for each other.

It should be noted that the interaction interval of software and hardware parts is not limited to the time period of encoding a full frame. The interval may be one macroblock (MB), one largest coding unit (LCU), one slice, or one tile. The interval may also be several MBs, several LCUs, several slices, or several tiles. The interval may also be one or more MB (or LCU) rows. When the granularity of the interaction interval is small, it's possible that data of the reconstructed frame (or post-processed frame) could be available for motion estimation. For example, under a slice-based interaction (i.e., video encoding is performed based on slices rather than frames), the hardware engine and the software engine of the hybrid video encoder 100 may process different slices of the same source frame M, and the reconstructed frame M−1 (which is derived from a source frame M−1 preceding the current source frame M) may be available at this moment. In this case, when the software engine of the hybrid video encoder 100 is processing a slice of the source frame M, the reconstructed frame M−1 may be used as a reference frame to provide reference pixel data referenced by motion estimation performed by the software engine. In above example shown in FIG. 3, the software engine may wait for the hardware engine within one frame interval when needed. However, this is not meant to be a limitation of the present invention. For example, the software engine of the hybrid video encoder 100 may be configured to perform motion estimation upon a plurality of successive source frames continuously without waiting for the hardware engine of the hybrid video encoder 100.

There are several embodiments without departing from the spirit of the present invention, and all have the same property that ME is implemented by software running on one or more programmable engines. One embodiment is that the software engine handles ME while the hardware engine handles MC, T, Q, IQ, IT, EC. The hardware engine may further handle post processing, such as DB and SAO, for different video encoding standards. Another embodiment is that the software engine handles ME and MC while the hardware engine handles T, Q, IQ, IT, EC. The hardware engine may further handle post processing, such as DB, and SAO. These alternative designs all have ME implemented by software (i.e., instruction execution), and thus fall within the scope of the present invention.

In another embodiment, the software encoder part of the hybrid video encoder 100 performs ME on one or multiple programmable engines. The result of ME performed by the software encoder part is then used by the hardware encoder part of the hybrid video encoder 100. The result of ME may include, but not limited to, motion vectors, coding modes of coding units, reference frame index, single reference frame or multiple reference frames, and/or other information which can be used to perform inter or intra coding. The software encoder part may further determine the bit budget and quantization setting of each coding region (e.g., macroblock, LCU, slice, or frame). The software encoder part may also determine the frame type of the current frame to be encoded, and the determination may be based on at least part of information of ME result. For example, the software encoder part may determine the current frame as I frame, P frame, B frame, or other frame type. The software encoder part may also determine the slice number and slice type of the current frame to be encoded, and the determination might be based on at least part of information of ME result. For example, the software encoder part may determine to have two slices in the current frame to be encoded. The software encoder part may determine the current frame having the first slice to be encoded as an I slice and the other slice as a P slice. The software encoder part may further determine the region of said I slice and P slice. The determination of the first slice to be encoded as an I slice may be based on the statistic information collected during the ME. For example, the statistic information may include the video content complexity or the activity information of a region of whole frame, the motion information, the ME cost function information or other information generated from the ME on the first slice.

The software encoder part may perform a coarse motion estimation based on a down-scaled source frame (which is derived from an original source frame) and a down-scaled reference frame (which is derived from an original reference frame). The result of coarse motion estimation is then delivered to hardware encoder part. The hardware encoder part may perform final or fine motion estimation and corresponding motion compensation. On the other hand, the hardware encoder part may directly perform motion compensation without performing final motion estimation.

The software encoder part may further get the exact coding result from hardware encoder part to determine the search range of the following frame or frames to be encoded. For example, a vertical search range +/−48 is applied to encode a first frame. The coding result of this frame may indicate coded motion vectors are mainly within a range of +/−16 in vertical search range. The software encoder part then determines to shrink the vertical search range to +/−32 and apply this range for encoding a second frame. By way of example, but not limitation, the second frame may be any frame following the first frame. The determined search range can be further delivered to hardware encoder part for motion estimation or other processing. The determination of search range can be treated as a part of motion estimation performed by software video encoder.

The software encoder part may further get motion information from another external unit to determine the search range. The external device unit may be a frame processing engine such as an image signal processor (ISP), electronic/optical image stabilization unit, graphic processing unit (GPU), a display processor, a motion filter, or a positional sensor. If a first frame to be encoded is determined as a static scene, the software encoder part may determine to shrink the vertical search range to +/−32 and apply this range for encoding this first frame.

In a case where the video standard is HEVC (High Efficiency Video Coding)/H.265, the software encoder part may also determine the tile number and tile parameter of the current frame to be encoded, and the determination might be based on at least part of information of ME result. For example, the software encoder part may determine to have two tiles, which each is 960×1080, in the current frame to be encoded for 1080 p encoding. The software encoder part may also determine to have two tiles, which each is 1920×540, in the current frame to be encoded for 1080 p encoding. These decisions then are used by the hardware encoder part to complete other processing of encoding.

The software encoder part takes advantage of cache buffer(s) of programmable engine (s) to store at least part of the current source frame data and at least part of the reference frame, leading to improved encoding performance due to lower data access latency. The reference frame could be the reconstructed frame or the post-processed frame. The cache buffer 113/115/117 used by the hybrid video encoder 100 may be level one cache (s), level two cache (s), level three cache (s), or even higher level cache(s).

For clarity and simplicity, it is assumed that the software engine of the hybrid video encoder 100 is implemented using the CPU subsystem 106. Hence, when performing motion estimation, the software engine (i.e., CPU subsystem 106) fetches the source frame and the reference frame from a large-sized frame buffer (e.g., off-chip memory 12). The hardware engine (i.e., VENC subsystem 108) will get source frame data or reference frame data from the cache buffer 117 of the software engine when the requested data is available in the cache buffer 117. Otherwise, source frame data or reference frame data will still be accessed from the large-sized frame buffer.

In this embodiment, a cache coherence mechanism is employed to check if the aforementioned data is inside the cache buffer 117 or not. The cache coherence mechanism fetches the data in the cache buffer 117 when the data is inside the cache buffer 117 or passes the data access request (i.e., a read request) to the memory controller 110 to get the requested data in the frame buffer. In other words, the cache controller of the CPU subsystem 106 serves a data access request issued from the hardware engine by using the cache buffer 117. When a cache hit occurs, the cache controller returns the cached data. When a cache miss occurs, the memory controller 110 will receive the data access request for those data desired by the hardware engine, and perform the data access transaction.

Two types of cache coherence mechanism can be applied in this embodiment. One is a conservative cache coherence mechanism, and the other is an aggressive cache coherence mechanism. To reduce the interference from the data access request issued from the hardware engine, the conservative cache coherence mechanism for the software engine and the hardware engine may be used. The conservative cache coherence mechanism handles only the read transaction; besides, when the data is not inside the cache buffer 117, no cache miss happens and no data replacement is performed. For example, a cache controller (not shown) inside the software engine or a bus controller (not shown) of the system 10 monitors/snoops the read transaction addresses on the bus 101 to which the software engine (CPU subsystem 106) and the hardware engine (VENC subsystem 108) are connected. When a transaction address of a read request issued by the hardware engine matches an address of a cached data inside the cache buffer 117, a cache hit occurs, and the cache controller directly transmits the cached data to the hardware engine.

It should be noted that the write transaction from the hardware engine is always handled by the controller of the next memory hierarchical organization, usually the off-chip memory 12 or the next level cache buffer. Hence, the cache controller of the CPU subsystem 106 may determine whether a data access request issued from the VENC subsystem 108 is to access the cache buffer 117 or a storage device (e.g., off-chip memory 12) different from the cache buffer 117. When the data access request issued from the VENC subsystem 108 is a write request, it is determined that the write request is to access the storage device (e.g., off-chip memory 12). Hence, data transaction between the VENC subsystem 108 and the storage device (e.g., off-chip memory 12) is performed without through the cache buffer 117. When the software engine does need the write data from the hardware engine, a data synchronization mechanism will be applied to indicate that the write data is available for the software engine. Further details of the data synchronization mechanism will be described later.

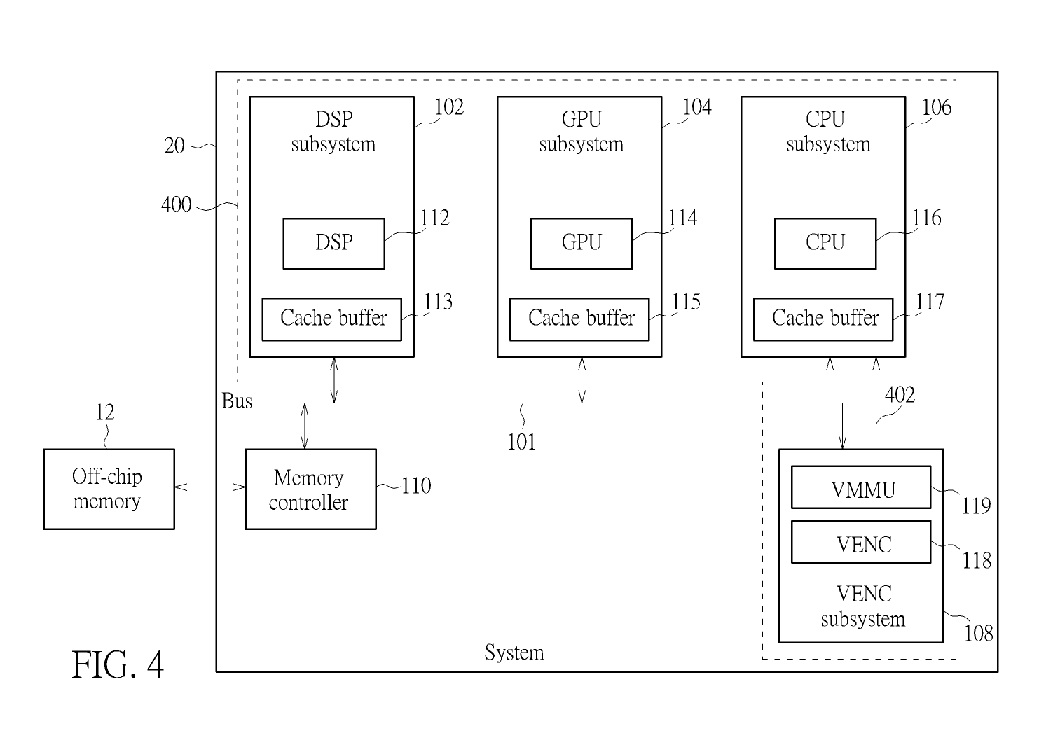

On the other hand, to let the hardware engine take more advantage of cache buffer (s) of programmable engine (s), the aggressive cache coherence mechanism may be used. Please refer to FIG. 4, which is a diagram illustrating a hybrid video encoder 400 according to a second embodiment of the present invention. The major difference between system 10 shown in FIG. 1 and system 20 shown in FIG. 4 is that a dedicated cache write line (i.e., an additional write path) 402 is implemented between the software engine and the hardware engine, thus allowing the hardware engine to write data into a cache buffer of the software engine. For clarity and simplicity, it is also assumed that the software engine is implemented by the CPU subsystem 106, and the hardware engine is implemented by the VENC subsystem 108. However, this is for illustrative purposes only, and is not meant to be a limitation of the present invention.

In a case where at least the motion estimation is performed by the CPU 116 of the CPU subsystem 106 which acts as the software engine, a cache write line is connected between the CPU subsystem 106 and the VENC subsystem 108. As mentioned above, the cache controller inside the programmable engine (e.g., CPU subsystem 106) monitors/snoops the read transaction addresses on the bus to which the programmable engine and the hardware engine (VENC subsystem 108) connects. Hence, the cache controller of the CPU subsystem 106 may determine whether a data access request issued from the VENC subsystem 108 is to access the cache buffer 117 or a storage device (e.g., off-chip memory 12) different from the cache buffer 117. When the data access request issued from the VENC subsystem 108 is a read access and the requested data is available in the cache buffer 117, a cache hit occurs and makes the cache controller to transmit requested data from the cache buffer 117 to the VENC subsystem 108. When the data access request issued from the VENC subsystem 108 is a read access and the requested data is not available in the cache buffer 117, a cache miss occurs and makes the cache controller to issue a memory read request to its next memory hierarchical organization, usually the off-chip memory 12 or the next level cache buffer. The read data returned from the next memory hierarchical organization then replaces a cache line or an equal-amount data in the cache buffer 117. The read data returned from the next memory hieratical organization is also transferred to the VENC subsystem 108.

When the data access request from the VENC subsystem 108 is a write request for storing a write data into the cache buffer 117 of the CPU subsystem 106, “write back” or “write through” policy could be applied. For the write back policy, the write data from the VENC subsystem 108 is transmitted to the CPU subsystem 106 and thus written into the cache buffer 117 initially via the dedicated cache write line 402. The write data from the VENC subsystem 108 is written into the next memory hierarchical organization through the bus 101 when the cache blocks/lines containing the write data are about to be modified/replaced by new content. For the write through policy, the write data from the VENC subsystem 108 is synchronously written into the cache buffer 117 through the dedicated cache write line 402 and the next memory hierarchical organization through the bus. As a person skilled in the art can readily understand details of write back policy and write through policy, further description is omitted here for brevity.

In addition to the software encoder part, an operation system (OS) may also run on the same programmable engine(s). In this case, in addition to the cache buffer, the programmable engine also has a memory protect unit (MPU) or memory management unit (MMU), in which a translation of virtual addresses to physical addresses is performed. To make the data stored in the cache buffer being accessed by the hardware engine, an address synchronization mechanism which ensures the same entry of the cache buffer can be correctly addressed and accessed by the hardware engine and software engine is applied. For example, the data access request issued from the VENC subsystem 108 is processed by another translation of virtual addresses to physical addresses via the VMMU 119, and this translation function is synchronous with the one inside the CPU subsystem 106.

To further make use of the cache buffer, a data synchronization mechanism is applied. The data synchronization mechanism helps to increase the opportunity that the data to be read is already in the cache buffer and therefore reduces the probability of obtaining data from the next memory hierarchical organization, e.g., the off-chip memory 12 or the next level cache buffer. The data synchronization mechanism also helps to reduce the opportunity of the cache miss or data replacement of the cache buffer.

The data synchronization mechanism includes an indicator (e.g., IND as shown in FIG. 3) that notifies the hardware engine (e.g., VENC subsystem 108) the desired data is now available in the cache buffer of the software engine (e.g., cache buffer 117 of CPU subsystem 106). For example, when the software engine finishes performing ME of a frame, the software engine sets the indicator. The hardware engine then performs remaining encoding processing on the same frame. The data read by the software engine, such as the source frame data and the reference frame data, are likely still inside the cache buffer. More specifically, when the granularity of the interaction interval as mentioned above is set smaller, it is more likely that data read by the software engine are still available in the cache buffer of the software engine when the hardware engine is operative to perform remaining encoding processing on the same frame previously processed by the software engine. Therefore, the hardware engine can read these data from the cache buffer instead of the next memory hierarchical organization (e.g., off-chip memory 12). Furthermore, the result generated by the software engine, such as the motion vectors, the motion compensated coefficient data, the quantized coefficients, the aforementioned intermediate data, is also likely still inside the cache buffer of the software engine. Therefore, the hardware engine can also read these data from the cache buffer instead of the next memory hierarchical organization (e.g., off-chip memory 12). The indicator can be implemented using any feasible notification means. For example, the indicator may be a trigger, a flag or a command queue of the hardware engine.

Alternatively, a more aggressive data synchronization mechanism may be employed. For example, when the software engine (e.g., CPU subsystem 106) finishes performing ME on a coding region, such as a number of macroblocks in a full frame, the software engine sets the indicator. That is, the indicator is set to notify the hardware engine (e.g., VENC subsystem 108) each time ME of a portion of a full frame is finished by the software engine. The hardware engine then performs remaining encoding processing on the portion of the frame. The data read by the software engine, such as the source frame data and the reference frame data, and the data generated by the software engine, such as the motion vectors and the motion compensated coefficient data, are also likely still inside the cache buffer of the soft engine. Therefore, the hardware engine can read these data from the cache buffer instead of the next memory hierarchical organization (e.g., off-chip memory 12). Similarly, the indicator can be implemented using any feasible notification means. For example, the indicator may be a trigger, a flag or a command queue of the hardware engine. For another example, the indicator may be the position information of macroblocks be processed or to be processed, or the number of macroblocks be processed or to be processed.

Besides, the hardware engine can also apply similar data synchronization method to notify the software engine. For example, when the hardware engine finishes writing parts of reconstructed frame data (or post-processed frame data) to the cache buffer of the software engine, the hardware engine could also set an indicator. The indicator set by the hardware engine may be, for example, an interrupt, a flag, the position information of macroblocks be processed or to be processed, or the number of macroblocks be processed or to be processed, etc.

The data synchronization mechanism may also incorporate a stall mechanism, such that the software engine or hardware engine is stalled when the data synchronization mechanism indicates that a stall is required. For example, when the hardware engine is busy and can't accept another trigger of next processing, a stall indicator would be generated by the hardware engine and indicate the software engine to stall such that the data in the cache buffer of the software engine would not be overwritten, replaced, or flushed. The stall indicator can be implemented using any feasible notification means. For example, the stall indicator may be a busy signal of the hardware engine or the fullness signal of the command queue. For another example, the stall indicator may be the position information of macroblocks be processed or to be processed. For another example, the indicator may be the number of macroblocks be processed or to be processed.

In summary, a method and apparatus of implementing video encoding with collaborated hardware and software parts are proposed by the present invention. It mainly takes advantage of powerful programmable engine (s) and corresponding cache buffer (s) and partial application specific hardware to reduce the chip area cost. Specifically, the proposed hybrid video encoder at least lets motion estimation task implemented by software, while at least one main task (one of MC, T, Q, IT, IQ, IP, DF, and SAO) is implemented by hardware.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A video encoding method comprising:
performing a first part of a video encoding operation by a software engine with a plurality of instructions, wherein the first part of the video encoding operation comprises at least a motion estimation function;
delivering a motion estimation result generated by the motion estimation function to a hardware engine; and
performing a second part of the video encoding operation by the hardware engine.

2. The motion estimation function of claim 1, wherein the step of performing the first part of the video encoding operation comprises:
determining a search range of motion estimation; and
setting determined search range of motion estimation into the hardware engine.

3. The video encoding method of claim 1, wherein the software engine comprises a cache buffer, and the video encoding method further comprises:
serving a data access request issued from the hardware engine by using the cache buffer.

4. The video encoding method of claim 3, wherein the data access request is a read request for at least a portion of a target frame, where the target frame is a video source frame or a reference frame.

5. The video encoding method of claim 3, wherein a dedicated cache write line is connected between the hardware engine and the software engine, the data access request is a write request of a write data generated from the hardware engine, and the step of serving the data access request comprises:
storing the write data transmitted through the dedicated cache write line into the cache buffer.

6. The video encoding method of claim 3, further comprising:
performing address synchronization to ensure that a same entry of the cache buffer is correctly addressed and accessed by both of the software engine and the hardware engine.

7. The video encoding method of claim 3, further comprising:
performing data synchronization to notify one of the software engine and the hardware engine that a desired data is now available in the cache buffer.

8. The video encoding method of claim 7, further comprising:
when the data synchronization indicates that a stall is required for a specific engine of the software engine and the hardware engine, notifying the specific engine to stall.

9. The video encoding method of claim 7, further comprising:
fetching data from a storage device different from the cache buffer when the data is not available in the cache buffer.

10. The video encoding method of claim 1, wherein the second part of the video encoding operation comprises at least one of a motion compensation function, an intra prediction function, a transform function, a quantization function, an inverse transform function, an inverse quantization function, a post processing function, and an entropy encoding function; when the motion estimation function is performed, a video source frame is used as a reference frame needed by motion estimation; and when the motion compensation function is performed, a reconstructed frame is used as a reference frame needed by motion compensation.

11. A video encoding method comprising:
performing a first part of a video encoding operation by a software engine with a plurality of instructions and a cache buffer;
performing a second part of the video encoding operation by a hardware engine;
performing data transfer between the software engine and the hardware engine through the cache buffer; and
performing address synchronization to ensure that a same entry of the cache buffer is correctly addressed and accessed by both of the software engine and the hardware engine.

12. The video encoding method of claim 11, wherein the first part of the video encoding operation comprises at least a motion estimation function.

13. The video encoding method of claim 11, further comprising:
performing data synchronization to notify one of the software engine and the hardware engine that a desired data is now available in the cache buffer.

14. The video encoding method of claim 11, wherein the step of performing the data transfer between the software engine and the hardware engine comprises:
receiving a write data generated from the hardware engine through a dedicated cache write line connected between the hardware engine and the software engine; and
storing the received write data into the cache buffer.

15. The video encoding method of claim 11, further comprising:
performing cache access conflict handling to coordinate a cache buffer access order when there are data access requests issued by the software engine and the hardware engine.

16. The video encoding method of claim 11, further comprising:
determining whether a data access request issued from the hardware engine is to access the cache buffer or to access a storage device different from the cache buffer.

17. The video encoding method of claim 16, further comprising:
when it is determined that the data access request is to access the storage device, performing data transaction between the hardware engine and the storage device without through the cache buffer.

18. The video encoding method of claim 16, further comprising:
when it is determined that the data access request is to access the cache buffer, and the data access request is a read request, transmitting requested data from the cache buffer to the hardware engine if there is a cache hit.

19. The video encoding method of claim 16, further comprising:
when it is determined that the data access request is to access the cache buffer, and the data access request is a read request, generating cache miss information if requested data is not available in the cache buffer.

20. A hybrid video encoder comprising
a software engine, arranged for performing a first part of a video encoding operation by executing a plurality of instructions, wherein the first part of the video encoding operation comprises at least a motion estimation function; and
a hardware engine, coupled to the software engine, the hardware engine arranged for receiving a motion estimation result generated by the motion estimation function, and performing a second part of the video encoding operation.

21. A hybrid video encoder comprising:
a software engine, arranged for performing a first part of a video encoding operation by executing a plurality of instructions, wherein the software engine comprises a cache buffer; and
a hardware engine, arranged for performing a second part of the video encoding operation, wherein data transfer is performed between the software engine and the hardware engine through the cache buffer, and the hardware engine further performs address synchronization to ensure a same entry of the cache buffer is correctly addressed and accessed by the software engine and the hardware engine.
